(19) United States
(12) Patent Application Publication
(10) Pub. No.: US 2017/0115076 A1
(43) Pub. Date: Apr. 27, 2017

(54) SURFACE-TREATED ALUMINUM ALLOY AND SURFACE-TREATED ALUMINUM ALLOY CLAD MATERIAL

(71) Applicant: Kabushiki Kaisha Kobe Seiko Sho (Kobe Steel, Ltd.), Kobe-shi (JP)

(72) Inventor: Shinji SAKASHITA, Kobe-shi (JP)

(73) Assignee: Kabushiki Kaisha Kobe Seiko Sho (Kobe Steel, Ltd.), Kobe-shi (JP)

(21) Appl. No.: 15/298,334

(22) Filed: Oct. 20, 2016

(30) Foreign Application Priority Data
Oct. 26, 2015 (JP) 2015-209993

(51) Int. Cl. F28F 19/06; B23K 35/28; C22C 21/00

(52) U.S. Cl. CPC F28F 19/06; C22C 21/00; B23K 35/286

(57) ABSTRACT

The present invention provides an aluminum alloy and an aluminum alloy clad material which are capable of retaining corrosion resistance even when a sacrificial material is not used.

The present invention is a surface-treated aluminum alloy, in which: a surface film is formed at least on one surface of the aluminum alloy; the thickness of the surface film is 0.1 to 10 μm; a material forming the surface film contains oxides having a standard free energy of formation of 500 kJ/mol or less at a temperature of 500 K by 80% by mass or more in total; and the average particle size of the oxides is 5 to 50 nm.

### FIELD OF THE INVENTION

The present invention relates to: a surface-treated aluminum alloy and a surface-treated aluminum alloy clad material, those being superior in corrosion resistance; in particular a surface-treated aluminum alloy and a surface-treated aluminum alloy clad material, those being used as a brazing sheet used for a heat exchanger or the like in an automobile.

### BACKGROUND OF THE INVENTION

A heat exchanger such as a radiator, a condenser, or an evaporator mounted on an automobile is manufactured by forming, assembling, and brazing a sheet of an aluminum alloy which is lightweight and superior in thermal conductivity in many cases.

In the case of a tube for a radiator or the like for example, the outer surface of such an aluminum alloy is exposed to the atmosphere and the inner surface is exposed to cooling water. When the aluminum alloy is exposed to such a corrosive environment, it is concerned that corrosion (pitting corrosion) advances locally and leads to form a through-hole.

As a corrosion protection measure for a tube outer surface, it is known that a method of bringing a fin material comprising an Al—Zn alloy or the like having a potential lower than an aluminum alloy constituting a tube into contact, a so-called cathodic protection method (galvanic protection method), is generally adopted and is effective. Also as a corrosion protection measure in the case of bringing a corrosive aqueous solution in contact with a tube inner surface, the cathodic protection method is frequency applied and specifically a tube generally comprises a clad material formed by stacking a sacrificial material comprising an Al—Zn alloy or the like having a relatively lower potential so as to function as a sacrificial anode to an aluminum alloy of a substrate (core material) on the inner surface side of the material. Further, a measure of adding a corrosion inhibition agent (inhibitor) to cooling water is also used in combination.

In addition, when an aluminum alloy is applied to a heat exchanger, a clad material (brazing sheet) formed by cladding a brazing material comprising an Al—Si alloy on one surface or both the surfaces in addition to a sacrificial material is used for brazing in many cases.

Meanwhile, the reduction of the thickness of a heat exchanger material is required from the viewpoint of the weight reduction and downsizing of a device and a thin aluminum alloy clad material of about 0.2 mm in thickness is used for example. In order to secure a strength required of a heat exchanger even when the thickness is reduced in this way, the core material of an aluminum alloy is strengthened for example by adding appropriate amounts of alloying elements such as Mn, Si, and Cu.

In order to respond to the recent needs for automobile weight reduction, the weight reduction of a heat exchanger for an automobile is also required and the request for the additional thickness reduction of a material used for a heat exchanger is uplifted. When the thickness of a material is intended to be reduced further, a higher strength is necessary and the increase of strength by optimizing alloy components and heat treatment conditions is studied. The increase of strength by optimizing alloy components and heat treatment conditions has a limitation however and to reduce the thickness of a sacrificial material that contributes less to strength to the greatest possible extent is studied.

Further, a heat exchanger material has a need for a longer service life and the improvement of corrosion resistance is required. If the thickness of a sacrificial material is reduced from the viewpoint of the strengthening however, the life of sacrificial protection shortens and moreover perforation (penetration) caused by corrosion tends to occur when a sheet thickness is reduced. For the reason, a more sophisticated corrosion-resistant technology is required and the improvement of corrosion resistance by the optimization of the components of an Al—Zn based alloy as a sacrificial material and the like are studied (Japanese Unexamined Patent Application Publication No. 2013-204078).

Furthermore, the securement of corrosion resistance by surface treatment is also studied and a corrosion-resistant treatment method of an aluminum heat exchanger by applying a hydrophilic treatment liquid and successively applying baking treatment is disclosed in Japanese Unexamined Patent Application Publication No. 2011-131206 for example. In the technology, a film mainly comprising a hydrophilic resin having a hydroxyl group, a carboxyl group, an amide group, an amino group, or the like in a molecule is formed.

### SUMMARY OF THE INVENTION

In a resin film according to the corrosion-resistant treatment method described in Japanese Unexamined Patent Application Publication No. 2011-131206 however, a corrosive material permeates easily through the film at a temperature exceeding a glass-transition point and corrosion resistance deteriorates extremely. Consequently, a sufficient corrosion prevention effect cannot be obtained in many cases. Meanwhile, such high corrosion-resistant technologies as stated above can cope with the thickness reduction and strengthening to some extent but higher thickness reduction and strengthening are required and ultimately a sacrificial material which does not contribute to strength is considered to be avoided.

The present invention has been established in view of the above situation and an object of the present invention is to provide an aluminum alloy and an aluminum alloy clad material capable of retaining corrosion resistance even when a sacrificial material is not used.

The present inventors, as a result of earnestly studying: have found that an aluminum alloy and an aluminum alloy clad material, those being superior in corrosion resistance, can be obtained by forming a surface film having a specific characteristic at least on one surface of an aluminum alloy; and have completed the present invention.

That is, the present invention relates to the following [1] to

[1] A surface-treated aluminum alloy, wherein: a surface film is formed at least on one surface of the aluminum alloy; the thickness of the surface film is 0.1 to 10 μm; a material forming the surface film contains oxides having a standard free energy of formation of 500 kJ/mol or less at a temperature of 500 K by 80% by mass or more in total; and the average particle size of the oxides is 5 to 50 nm

[2] A surface-treated aluminum alloy according to [1], wherein the surface film contains one or more kinds selected from the group consisting of Ti_{02,} Zr_{02,} Si_{02,} MgO, and CaO by 80% by mass or more in total as the oxides.

[3] A surface-treated aluminum alloy according to [1] or [2], wherein the aluminum alloy comprises Si: 0.3% to 1.5% by mass, Mn: 0.6% to 2.0% by mass, Cu: 0.1% to 3.0% by mass, Ti: 0.05% to 0.5% by mass, Fe: 0.01% to 0.5% by mass, and Zn: 0.5% by mass or less, with the remainder consisting of Al and unavoidable impurities.

[4] A surface-treated aluminum alloy according to [3], wherein the aluminum alloy further comprises one or more kinds selected from Cr: 0.05% to 0.5% by mass, Zr: 0.05% to 0.5% by mass, and Mg: 0.05% to 1.0% by mass.

[5] A surface-treated aluminum alloy clad material, wherein: a skin material is formed on one surface of an aluminum alloy as a core material and a surface film is formed on the other surface; the skin material comprises an Al—Si based alloy having a thickness of 10 μm or more; and the core material on the surface of which the surface film is formed is a surface-treated aluminum alloy according to any one of [1] to [4].

[6] A surface-treated aluminum alloy according to any one of [1] to [4] used for a heat exchanger in an automobile.

[7] A surface-treated aluminum alloy clad material according to [5] used for a heat exchanger in an automobile.

A surface-treated aluminum alloy or a surface-treated aluminum alloy clad material according to the present invention can secure corrosion resistance required for a heat exchanger or the like even when a sacrificial material is not used and hence an aluminum alloy or an aluminum alloy clad material having a higher strength can be obtained even though the thickness is not increased. In other words, a strength identical to an aluminum alloy or an aluminum alloy clad material using a sacrificial material can be obtained by a thinner material and hence the material is effective for the weight reduction and downsizing of a heat exchanger.

An aluminum alloy clad material according to the present invention is very suitable also as a radiator tube material which regards inner corrosion particularly caused by cooling water as important.

### DETAILED DESCRIPTION OF THE PREFERRED EMBODIMENTS

Usually a natural oxide film (AlO₃) is formed on the surface of an aluminum (hereunder referred to merely as “alumi” occasionally) alloy and has the function of inhibiting the corrosion of an alumi alloy substrate. It is publicly known however that, since the thickness of a natural oxide film is about a few nanometers, the natural oxide film is destroyed easily by a film destruction function of a Cl ion or the like in a corrosive environment, an alumi alloy substrate is exposed to the corrosive environment, and corrosion (pitting corrosion) advances.

Further, it is publicly known that a thermodynamically stable oxide can act as a protective film of a metallic material and it is conceivable that a corrosion prevention effect exceeding such a natural oxide film as stated above can be obtained by forming a stable oxide having a thickness larger than the natural oxide film on an alumi alloy surface. In the case of forming a film comprising an ordinary stable oxide on an alumi alloy however, local corrosion may be caused by the intrusion of a corrosive material from between oxide particles sometimes and an enough corrosion resistance is not obtained very often.

Although such intrusion of a corrosive material from between oxide particles can be inhibited by increasing a film thickness, the increase of a film thickness hinders a good thermal conductivity that is a feature of an aluminum alloy, thus is not desirable, and is hardly applicable particularly to a heat exchanger.

In view of the above situation, the present inventors: have studied a method of securing corrosion resistance while a sacrificial material of an aluminum alloy clad material is not used; and resultantly have found that a superior corrosion prevention effect can be obtained without hindering a heat exchange efficiency by forming a surface film containing a thermodynamically stable oxide by a predetermined amount or more and optimizing the thickness of the film and the size of the oxide particles. The present inventors have further found that a more superior corrosion prevention effect can be obtained by the synergic effect with the film by optimizing the chemical components of an aluminum alloy.

That is, the present invention is a surface-treated aluminum alloy, wherein: a surface film is formed at least on one surface of the aluminum alloy; the thickness of the surface film is 0.1 to 10 μm; a material forming the surface film contains oxides having a standard free energy of formation of 500 kJ/mol or less at a temperature of 500 K by 80% by mass or more in total; and the average particle size of the oxides is 5 to 50 nm.

Further, the present invention also relates to an aluminum alloy clad material wherein: an aluminum alloy is used as a core material; a skin material is formed on one surface of the aluminum alloy; and a surface film is formed on the other surface.

Factors such as a surface film, a chemical composition, and others forming a surface-treated aluminum alloy and an aluminum alloy clad material according to the present invention are explained hereunder.

### <Surface Film F>

In a surface-treated aluminum alloy according to the present invention, a surface film F is formed at least on one surface of the aluminum alloy. The surface-treated aluminum alloy can have a superior corrosion resistance by having the film F have a thickness of 0.1 to 10 μm, having a material forming the film F contain oxides having a standard free energy of formation of 500 kJ/mol or less at a temperature of 500 K by 80% by mass or more in total, and having the oxides have an average particle size of 5 to 50 nm.

With regard to the thickness of the film F, if the film F is too thin, a corrosive material intrudes from between oxide particles, local corrosion is caused, and thus corrosion resistance cannot be obtained. The film thickness has to be 0.1 μm or more in order to inhibit a corrosive material from intruding and obtain a sufficient corrosion resistance. The lower limit of the thickness of the film F is preferably 0.15 μm or more and yet preferably 0.2 μm or more.

Meanwhile, if the film F is too thick, heat exchange efficiency deteriorates and hence the thickness has to be 10 μm or less. The upper limit of the thickness of the film F is preferably 9 μm or less and yet preferably 8 μm or less.

The thickness of the film F can be measured by observing a cross section of a film part with a SEM (Scanning Electron Microscope) or a TEM (Transmission Electron Microscope).

Oxides forming the film F require thermodynamic stability and, in the present invention, the constituent material is defined by using a standard free energy of formation as the scale. In consideration of the temperature range in which an alumi alloy is used for a heat exchanger, the stability of oxides in a service environment can be evaluated by a standard free energy of formation at a temperature of 500 K.

In the case of oxides having a standard free energy of formation exceeding 500 kJ/mol, the stability in a service environment is insufficient and hence a sufficient corrosion resistance is not obtained. Oxides forming the film F according to the present invention therefore have to have a standard free energy of formation of 500 kJ/mol or less at a temperature of 500 K. Here, a standard free energy of formation at a temperature of 500 K is a value intrinsic to oxides.

The effect of securing a good corrosion resistance can be obtained when oxides are 80% by mass or more in total in materials forming a surface film F. The oxides are preferably 85% by mass or more and yet preferably 90% by mass or more in total.

The type and content of oxides forming a surface film F can be measured by an X-ray diffraction (XRD) method.

As oxides suitable for a film F according to the present invention, TiO₂, ZrO₂, SiO₂, MgO, CaO, Al₂O₃, Cr₂O₃, La₂O₃, Ce₂O₃, Y₂O₃, Nb₂O₅, Ta₂O₅, and others are named. Among those, TiO₂, ZrO₂, SiO₂, MgO, and CaO are more suitable because they have a good surface treatability to an aluminum alloy. A more superior corrosion prevention effect can be obtained by containing one or more kinds selected from the group consisting of TiO₂, ZrO₂, SiO₂, MgO, and CaO by 80% by mass or more and yet preferably 85% by mass or more in total.

The particle sizes of oxides forming a film F are involved in inhibiting a corrosive material from intruding and hence have to be optimized. If the particle sizes of oxides are too small, a solvent between particles evaporates while a film is formed, volume contraction increases, and hence defects such as cracks tend to be generated in the film. As a result, a corrosive material cannot be inhibited from intruding and local corrosion is caused sometimes. In contrast, if the particle sizes of oxides are too large, a gap is formed between particles, a dense film is not obtained, and hence it is concerned that a corrosive material cannot be inhibited from intruding from between particles and local corrosion may be caused.

Consequently, the average particle size of oxides forming a film F has to be 5 nm or more to 50 nm or less. The lower limit of the average particle size of oxides is preferably 6 nm or more and yet preferably 7 nm or more. The upper limit of the average particle size of oxides is preferably 48 nm or less and yet preferably 46 nm or less.

Oxides can be obtained for example by a chemical method (liquid phase method) such as an alkoxide method of obtaining oxide particles by hydrolyzing a metal alkoxide. On this occasion, the average particle size of oxides can be adjusted by treatment conditions such as a synthesis temperature and a metal alkoxide concentration. Further, the average particle size of oxides can be measured by a dynamic light scattering method.

A method of forming a film F is not particularly limited and for example a film F can be formed by applying a substance (dispersion liquid) formed by dispersing oxide particles forming the film F in an appropriate solvent on the surface of an aluminum alloy and drying it. As a solvent, pure water or an organic solvent such as alkyl silicate can be exemplified.

By such a method, since an oxide in a solvent is stable and does not cause chemical reaction or the like, the particle sizes of the dispersed oxides do not change and the mixed composition of the oxides comes to be the composition of a film F without change. Consequently, the thickness of a film F can be adjusted by controlling the average particle size of oxide particles dispersed in a solvent in the range stipulated in the present invention and adjusting an oxide particle concentration in a dispersion liquid and a coating weight.

After a dispersion liquid is applied on the surface of an aluminum alloy, it is also possible to heat it to a temperature of about 100° C. to 300° C. and dry it for example. Since the time of a drying process can be reduced by applying heating and drying in this way, the time required for forming a film F can be reduced. A method of the heating and drying may be: a method of blowing warm air with a dryer or the like; or a method of inserting an aluminum ally into an atmospheric heat-treating furnace whose temperature is adjusted.

A manufacturing method of oxide particles for forming a film F is also not particularly limited and oxide particles may be manufactured by an ordinary solid phase method, liquid phase method, or gas phase method.

A film F may be formed on one surface or on both the surfaces of an aluminum alloy. In the case of using an aluminum alloy as the core material of a clad material however, a film F is formed on one surface and a skin material, which will be described later, is formed on the other surface.

It is possible to: form a film F according to the present invention on the surface of an aluminum alloy or an aluminum alloy acting as the core material of an aluminum alloy clad material, which will be described later, beforehand and then manufacture a device such as a heat exchanger; or manufacture a device such as a heat exchanger with an aluminum alloy or an aluminum alloy clad material by brazing or welding and then form a film F on the surface.

<Chemical Components of Aluminum Alloy (Core Material of Clad Material)>

An aluminum alloy or an aluminum alloy acting as the core material of an aluminum alloy clad material (hereunder referred to as “aluminum alloy” collectively) contains preferably Si, Mn, Cu, Ti, Fe, and Zn and additionally contains yet preferably one or more kinds selected from the group consisting of Cr, Zr, and Mg. Here, the remainder of the aluminum alloy consists of Al and unavoidable impurities. Here, the components of an aluminum alloy can be measured by an emission spectrometric analysis stipulated in JIS H 1305:2005 or the like.

The respective elements and contents are explained hereunder. Here, “to” representing a range of numerical values in the present specification is used in the sense of including the numerical values described before and after as the lower limit and the upper limit.

### (Si: 0.3% to 1.5% by Mass)

Si has the effect of improving the strength of an aluminum alloy and can further increase the strength particularly by coexisting with Mn and thus forming an Al—Mn—Si based intermetallic compound. In order to secure a sufficiently high strength in an aluminum alloy clad material, an Si content in a core material is preferably 0.3% by mass or more, yet preferably 0.35% by mass or more, and still yet preferably 0.4% by mass or more.

On the other hand, Si lowers the melting point of an aluminum alloy and hence a core material may melt during brazing if Si is added excessively in some cases. Consequently, an Si content in a core material is preferably 1.5% by mass or less, yet preferably 1.4% by mass or less, and still yet preferably 1.3% by mass or less.

### (Mn: 0.6% to 2.0% by Mass)

Mn has the effect of improving the strength of an aluminum alloy in the same manner as Si and can further increase the strength particularly by coexisting with Si and thus forming an Al—Mn—Si based intermetallic compound. Further, Mn raises the melting point of an aluminum alloy and hence is necessary for preventing the problem of causing a core material to melt during brazing by adding an alloy element such as Si that lowers the melting point.

In order to sufficiently secure strength and the prevention of melting point decrease in an aluminum alloy clad material, a Mn content in a core material is preferably 0.6% by mass or more, yet preferably 0.65% by mass or more, and still yet preferably 0.7% by mass or more.

On the other hand, if Mn is added excessively, a coarse crystallized substance precipitates and the formability of an aluminum alloy clad material may deteriorate in some cases. Consequently, an Mn content in a core material is preferably 2.0% by mass or less, yet preferably 1.9% by mass or less, and still yet preferably 1.8% by mass or less.

### (Cu: 0.1% to 3.0% by Mass)

Cu has the effect of improving the strength of an aluminum alloy in the same manner as Si and Mn and is necessary for increasing the strength of an aluminum alloy clad material. Further, Cu has the function of making the electric potential of an aluminum alloy noble. In order to sufficiently secure the effects, a Cu content in a core material is preferably 0.1% by mass or more, yet preferably 0.2% by mass or more, and still yet preferably 0.3% by mass or more.

On the other hand, if Cu is added excessively, a Cu compound precipitates abundantly at grain boundaries, grain boundary corrosion tends to occur, a melting point lowers, and a core material is caused to melt during brazing. Consequently, a Cu content in a core material is preferably 3.0% by mass or less, yet preferably 2.9% by mass or less, and still yet preferably 2.8% by mass or less.

### (Ti: 0.05% to 0.5% by Mass)

Ti distributes in layers in a core material, has the function of inhibiting pitting corrosion from progressing, and is necessary for improving local corrosion resistance. Further, Ti is necessary also for improving the strength of aluminum. In order to sufficiently exhibit the effects, a Ti content in a core material is preferably 0.05% by mass or more, yet preferably 0.06% by mass or more, and still yet preferably 0.07% by mass or more.

If a Ti content exceeds 0.5% by mass however, a coarse intermetallic compound of an Al—Ti based is caused and that comes to be a factor of cracking during forming process sometimes. Consequently, a Ti content in a core material is preferably 0.5% by mass or less, yet preferably 0.45% by mass or less, and still yet preferably 0.4% by mass or less.

### (Fe: 0.01% to 0.5% by Mass)

Fe has the effect of crystallizing and precipitating as an intermetallic compound and improving the strength of an aluminum alloy and is necessary for increasing the strength of an aluminum alloy clad material. In order to obtain the effect, an Fe content is preferably 0.01% by mass or more, yet preferably 0.02% by mass or more, and still yet preferably 0.03% by mass or more.

On the other hand, if an Fe content is excessive in excess of 0.5% by mass, not only forming processability deteriorates but also local corrosion may increase sometimes. Consequently, an Fe content in a core material is preferably 0.5% by mass or less, yet preferably 0.45% by mass or less, and still yet preferably 0.4% by mass or less.

### (Zn: 0.5% b_{y} Mass or Less)

Zn is an element that makes the corrosion potential and pitting corrosion potential of an aluminum alloy poor and deteriorates corrosion resistance and hence a Zn content is preferably reduced to the greatest possible extent. A Zn content allowable in the present invention is recommended to be preferably 0.5% by mass or less, yet preferably 0.4% by mass or less, and still yet preferably 0.3% by mass or less.

(One or More Kinds Selected from Cr: 0.05% to 0.5% by Mass, Zr: 0.05% to 0.5% by Mass, and Mg: 0.05% to 1.0% by Mass)

Cr and Zr have the effect of making the pitting corrosion potential of an aluminum alloy noble and improving corrosion resistance. Further, Cr and Zr are elements effective for increasing strength. In order to obtain the effects of the elements, preferably at least either one of Cr and Zr is contained by 0.05% by mass or more. A content of Cr or Zr is yet preferably 0.06% by mass or more and still yet preferably 0.07% by mass or more.

When Cr and Zr are added excessively however, a huge crystallized substance is created during casting and the production comes to be difficult sometimes. Consequently, a content of each of Cr and Zr is preferably 0.5% by mass or less, yet preferably 0.45% by mass or less, and still yet preferably 0.4% by mass or less.

Further, Mg, by coexisting with Si, has the function of forming an Mg₂Si compound during heating for brazing or the like and increasing strength. In order to obtain the effect, an Mg content in a core material is preferably 0.05% by mass or more, yet preferably 0.1% by mass or more, still yet preferably 0.11% by mass or more, and particularly preferably 0.12% by mass or more.

When Mg in a core material is added excessively however, brazability may deteriorates sometimes. Consequently, an Mg content is preferably 1.0% by mass or less, yet preferably 0.9% by mass or less, and still yet preferably 0.8% by mass or less.

That is, one or more kinds selected from Cr, Zr, and Mg is/are contained preferably and the contents on that occasion are described above.

In a core material (aluminum alloy) used for a surface-treated aluminum alloy clad material according to the present invention, the remainder of the above composition components consists of Al and unavoidable impurities (inevitable impurities). The unavoidable impurities may be included as long as the content is in the range of not hindering the effect of the present invention. The unavoidable impurities are acceptable as long as the content is about less than 1.0% by mass in total.

<Aluminum alloy clad material>

An aluminum alloy clad material according to the present invention is formed by using an aluminum alloy as a core material, forming a surface film F stated above on one surface of the aluminum alloy, and forming a skin material R on the other surface. The skin material R comprises an Al—Si based alloy and can be used as a clad material for a brazing tube or the like.

As an Al—Si based alloy forming a skin material R for brazing, for example an Al—Si alloy containing Si of 4% by mass or more to 12% by mass or less can be used and a 4045 alloy, a 4343 alloy, and others can be used.

When a skin material R is formed, it is also possible to add Zn by 1% by mass or more to 6% by mass or less for example in order to obtain a sacrificial protection effect after brazing.

When a skin material R is formed, apart from the composition components of the skin material R, the remainder consists of Al and unavoidable impurities. The unavoidable impurities may be included as long as the content is in the range of not hindering the effect of the present invention. The unavoidable impurities are acceptable as long as the content is about less than 1.0% by mass in total.

When a skin material R is formed, it is desirable to adjust the thickness of the skin material R in order to obtain a good brazability. If the skin material R is too thin, the amount of melted braze is insufficient during brazing and brazability deteriorates, for example brazing failure is likely to occur. Consequently, in order to secure brazability, the thickness of a skin material R is preferably 10 μm or more, yet preferably 12 μm or more, and still yet preferably 15 μm or more. The thickness of a skin material R can be measured by observing a cross section of a clad material.

In an aluminum alloy clad material according to the present invention, when Mg is contained in a core material (aluminum alloy), Mg disperses in a brazing material during brazing and brazability deteriorates in some cases. On this occasion, an intermediate material may be cladded between the core material and a skin material R in order to inhibit brazability from deteriorating.

As chemical components of an intermediate material, an aluminum alloy containing for example Si: 0.3% to 2.0% by mass, Mn: 0.6% to 2.0% by mass, Cu: 0.1% to 3.0% by mass, Ti: 0.05% to 0.5% by mass, and Fe: 0.01% to 0.5% by mass with the remainder consisting of Al and unavoidable impurities can be exemplified.

<Manufacturing Method of Aluminum Alloy>

Manufacturing methods of a surface-treated aluminum alloy and a surface-treated aluminum alloy clad material according to the present invention are not particularly limited as long as a surface film has the above characteristics and known methods can be used. An example is explained hereunder.

With regard to an aluminum alloy, an aluminum alloy of a component composition is melted and casted, further homogenization is applied if needed, and an ingot is obtained. The ingot is reduced to an intended thickness by rolling (hot rolling, cold rolling) or cutting.

With regard to an aluminum alloy clad material, firstly aluminum alloys of the respective component compositions of a core material S, a skin material R, and an intermediate material if needed are melted and casted, further homogenization is applied if needed, and respective ingots are obtained. The ingots are reduced to sheets having respective thicknesses conforming to an intended clad ratio by rolling (hot rolling, cold rolling) or cutting. Successively, an integrated sheet is formed by laminating the skin material R and the core material S or the skin material R, the intermediate material, and the core material S if needed in this order and cladding them by hot rolling. Further, the integrated sheet is cold rolled to a predetermined final thickness and thus an aluminum alloy clad material is obtained. Intermediate annealing may be applied in the cold rolling if needed.

### EXAMPLES

The present invention is hereunder explained more concretely in reference to examples and comparative examples, but is not limited to the examples, and can be carried out by adding modifications in the range conforming to the gist and the modifications are all included in the technological scope of the present invention.

### <Manufacturing of Test Specimen>

The chemical components (compositions) of aluminum alloys used for core materials S and skin materials R are shown in Tables 1 and 2 respectively. The aluminum alloys having the compositions are melted and casted respectively and ingots of 1 to 20 kg are manufactured respectively.

The ingots of the core materials S shown in Table 1 are subjected to homogenization for one hour at 500° C. to 550° C., then subjected to hot rolling and cold rolling, and formed into sheets having the thicknesses of 5 to 33 mm (S1 to S22).

The ingots of the skin materials R shown in Table 2 are subjected to homogenization for three hours at 500° C., then subjected to hot rolling and cold rolling, and formed into sheets having the thicknesses of 3 to 4 mm (R1 to R3).

TABLE 1
Component compositions (% by mass) of core materials, with
the remainder consisting of Al and unavoidable impurities

| Symbol | Si | Mn | Cu | Ti | Fe | Zn | Cr | Zr | Mg |
|---|---|---|---|---|---|---|---|---|---|
| S1 | 0.22 | 0.02 | 0.02 | — | 0.15 | 0.03 | — | — | — |
| S2 | 0.32 | 1.22 | 3.20 | 0.15 | 0.15 | 0.12 | — | — | — |
| S3 | 0.80 | 1.21 | 0.45 | 0.03 | 0.16 | 0.08 | — | — | — |
| S4 | 0.80 | 1.18 | 0.48 | 0.14 | 0.55 | 0.09 | — | — | — |
| S5 | 0.79 | 1.20 | 0.52 | 0.15 | 0.15 | 0.57 | — | — | — |
| S6 | 0.30 | 1.19 | 0.80 | 0.15 | 0.14 | 0.05 | — | — | — |
| S7 | 0.80 | 0.60 | 0.30 | 0.14 | 0.15 | 0.06 | — | — | — |
| S8 | 0.78 | 1.20 | 0.10 | 0.15 | 0.15 | 0.05 | — | — | — |
| S9 | 0.80 | 1.21 | 0.78 | 0.05 | 0.13 | 0.08 | — | — | — |
| S10 | 1.00 | 1.45 | 0.81 | 0.15 | 0.01 | 0.12 | — | — | — |
| S11 | 1.50 | 1.60 | 0.25 | 0.10 | 0.08 | 0.28 | — | — | — |
| S12 | 0.60 | 1.98 | 0.50 | 0.19 | 0.11 | 0.09 | — | — | 0.11 |
| S13 | 0.59 | 1.62 | 3.00 | 0.50 | 0.12 | 0.10 | 0.15 | — | — |
| S14 | 0.80 | 1.59 | 1.20 | 0.50 | 0.20 | 0.08 | — | 0.14 | — |
| S15 | 0.79 | 1.60 | 1.19 | 0.20 | 0.49 | 0.25 | 0.11 | — | 0.15 |
| S16 | 0.42 | 1.60 | 1.50 | 0.21 | 0.15 | 0.50 | — | 0.12 | 0.35 |
| S17 | 0.45 | 1.61 | 1.49 | 0.20 | 0.14 | 0.11 | 0.05 | 0.12 | — |
| S18 | 0.44 | 1.59 | 1.50 | 0.20 | 0.15 | 0.01 | 0.10 | 0.05 | 0.20 |
| S19 | 0.41 | 1.50 | 0.35 | 0.15 | 0.15 | 0.02 | — | — | 0.05 |
| S20 | 0.60 | 1.50 | 0.20 | 0.16 | 0.05 | 0.05 | 0.50 | — | — |
| S21 | 0.59 | 1.49 | 0.99 | 0.15 | 0.04 | 0.04 | — | 0.50 | — |
| S22 | 0.60 | 1.49 | 1.00 | 0.15 | 0.09 | 0.08 | — | — | 1.00 |

TABLE 2
Component compositions (% by mass) of skin materials R, with the
remainder consisting of A1 and unavoidable impurities

| Symbol | Si | Zn |
|---|---|---|
| R1 | 9.9 | — |
| R2 | 5.8 | 2.9 |
| R3 | 12.9 | 0.8 |

With regard to the clad materials shown in Nos. 8, 10, 12, 14, and 16 to 33 of Table 4, the sheets of the obtained core materials S and skin materials R are cut into a size of 150 mm×100 mm and are ground to prescribed thicknesses, respectively. Each of the skin materials R is laid on a surface of each of the core materials S, hot rolling is applied at 400° C. to 450° C., further cold rolling is applied, and thus aluminum alloy clad materials having a thickness of 300 μm are manufactured. The combinations of the core materials S and the skin materials R are as shown in Table 4. Heating treatment for five minutes at 600° C., which corresponds to a brazing condition, is applied to each of the obtained aluminum alloy clad materials.

Here, with regard to single materials of the core materials S, to which no skin materials R are formed, shown in Nos. 1 to 7, 9, 11, 13, and 15 of Table 4, the sheets having a thickness of 5 mm are hot rolled at 400° C. to 450° C., further cold rolled, and thus aluminum alloy sheets having a thickness of 300 μm are manufactured.

From each of the aluminum alloy clad materials or the single materials thus obtained, a test specimen 60 mm×50 mm in size is cut out. The cut-out test specimen 60 mm×50 mm in size is cleaned with acetone and dried. Successively, the part of 5 mm from the edge on a test surface and the surface other than the test surface are masked with Teflon (registered trade mark).

With regard to each of the single materials of the core materials S to which no skin materials R are formed, either of the surfaces of a test specimen is used as the test surface. With regard to each of the clad materials, the surface, to which no skin material R is formed, of each of the core materials S is used as the test surface.

On each of the test surfaces exposed from the masking, the following surface treatment is applied and a film F is formed.

In the surface treatment, a film is formed by mixing oxide particles in accordance with the compositions of the oxides described in Table 4, dipping a test specimen in a dispersion liquid prepared by dispersing the oxide particles in water, and drying the test specimen. Here, the standard free energies of formation of the used oxides are as shown in Table 3.

The comparative example of No. 1 is an untreated aluminum alloy to which a film F is not formed. No. 2 is an example in which the standard free energy of formation of the oxide forming the film F deviates from the stipulation. No. 3 is an example in which La₂O₃ satisfying the stipulation of the standard free energy of formation is contained as the oxides forming the film F but the composition deviates from the stipulation. Nos. 4 and 5 are examples of preparing La₂O₃ particles having average particle sizes of 3 nm and 56 nm respectively, those deviating from the stipulation, dispersing the particles in water, and applying filming treatment. Further, No. 6 is an example in which filming treatment is applied by using a processing liquid formed by dispersing La₂O₃ particles having an average particle size of 20 nm which satisfies the stipulation in water, but the filming treatment is applied by using the dispersion liquid having an La₂O₃ concentration of 0.05% by mass in the processing liquid, the film F is as thin as 0.04 μm, and the thickness does not satisfy the stipulation.

In contrast, No. 7 and the succeeding numbers are examples of preparing various kinds of oxide particles having average particle sizes in the range of the stipulation and applying filming treatment by using processing liquids prepared by dispersing the particles in water appropriately at the concentrations of 0.5% to 20% by mass. A film thickness is adjusted by controlling the temperature of a dispersion liquid to room temperature, setting the processing time (immersion time) at 60 seconds, and adjusting the oxide particle concentration in the dispersion liquid. The drying after the immersion is carried out by heating the test specimens for 30 minutes under the atmosphere of 150° C. The average particle size of the oxides forming a formed film is measured by a dynamic light scattering method. Further, the thickness of a film is measured by observing a cross section by SEM or TEM. The results are shown in Table 4. Here, the compositions of the oxides shown in Table 4 are the mixture ratios (% by mass) of the oxides added to the dispersion liquids.

TABLE 3
Standard free energy of formation of oxides at a temperature of
500 K (ΔG)

| Oxide | ΔG (kJ/mol) |
|---|---|
| ZnO | −300 |
| Cu₂O | −300 |
| TiO₂ | −800 |
| SiO₂ | −800 |
| Al₂O₃ | −1000 |
| ZrO₂ | −1000 |
| MgO | −1100 |
| CaO | −1200 |
| La₂O₃ | −1700 |
| Nb₂O₅ | −1700 |
| Ta₂O₅ | −1800 |

### <Corrosion Test Method>

As corrosion test, salt splay test (Test 1) of splaying a 5% NaCl aqueous solution at 35° C. is carried out. The test specimens of the aluminum alloys and the aluminum alloy clad materials are installed in a test chamber at an angle of 15° from the vertical. The test period is set at 28 days. Five pieces are tested for each of the aluminum alloys.

Further, as corrosion test for evaluating a corrosion characteristic in an environment of the radiator interior of an automobile, cyclic corrosion test (Test 2) by an OY liquid is carried out. The OY liquid as the test solution is a liquid of C:195 ppm, SO₄²: 60 ppm, Cu²⁺: 1 ppm, Fe³: 30 ppm, and pH: 3.0. Each of the test specimens is subjected to the temperature cycle of being immersed in the OY liquid, heating the test solution from room temperature to 88° C. for one hour with a water bath, holding 88° C. for 7 hours, successively being cooled to room temperature for one hour, and holding the room temperature for 15 hours at a frequency of one cycle per day. The test period is set at 84 days. Five pieces are tested for each of the aluminum alloys.

A Teflon tape used for masking is removed from each of the test specimens after the respective corrosion tests of Test 1 and Test 2 and corrosion products on each of the test specimens are removed by being immersed in a 60% nitric acid. Successively, each of the test specimens is subjected to water rinsing and acetone cleaning and dried and each corrosion status is evaluated.

In the evaluation of a corrosion status, firstly whether or not perforation by corrosion (corrosion penetration) exists is investigated by visually observing a test specimen. With regard to an aluminum alloy in all five test specimens of which no perforation is recognized, the local corrosion generation statuses of the five test specimens are observed with a microscope and the depths of the local corrosion are measured. The largest local corrosion depth in the five test specimens is defined as the maximum local corrosion depth of an aluminum alloy. The evaluation criterion of corrosion resistance in the corrosion test shown in Table 4 is as follows.

Excellent: all of five test specimens have neither corrosion penetration nor local corrosion

Very Good: all of five test specimens have no corrosion penetration but have local corrosion and the maximum local corrosion depth is less than 20 μm

Good: all of five test specimens have no corrosion penetration but the maximum local corrosion depth is 20 μm or more to less than 100 μm

Fair: all of five test specimens have no corrosion penetration but the maximum local corrosion depth is 100 μm or more

Poor: corrosion penetration is observed in at least one test specimen

TABLE 4
Outline of aluminum alloy test specimens and corrosion test results

| | Core material S | | Skin material R | | Film F | | | | | |
|---|---|---|---|---|---|---|---|---|---|---|
| | | Thick- | | Thick- | | Average | Thick- | Corrosion resistance | | |
| | | ness | | ness | | particle size | ness | evaluation result | | |
| No. | Material | (μm) | Material | (μm) | Composition of oxide | (nm) | (μm) | Test 1 | Test 2 | Remark |
| 1 | S1 | 300 | — | — | — | — | — | Poor | Poor | Comparative example |
| 2 | S1 | 300 | — | — | ZnO: 100% | 35 | 2.5 | Fair | Poor | Comparative example |
| 3 | S1 | 300 | — | — | La₂O₃: 70%, Cu₂O: 30% | 32 | 3.0 | Fair | Fair | Comparative example |
| 4 | S1 | 300 | — | — | La₂O₃: 100% | 3 | 2.0 | Fair | Fair | Comparative example |
| 5 | S1 | 300 | — | — | La₂O₃: 100% | 56 | 1.8 | Fair | Poor | Comparative example |
| 6 | S1 | 300 | — | — | La₂O₃: 100% | 20 | 0.04 | Poor | Poor | Comparative example |
| 7 | S1 | 300 | — | — | La₂O₃: 100% | 5 | 2.2 | Good | Good | Example |
| 8 | S1 | 280 | R1 | 20 | Al₂O₃: 100% | 5 | 1.8 | Good | Good | Example |
| 9 | S2 | 300 | — | — | Ta₂O₅: 100% | 25 | 0.12 | Good | Good | Example |
| 10 | S2 | 260 | R2 | 40 | Ta₂O₅: 100% | 25 | 0.10 | Good | Good | Example |
| 11 | S3 | 300 | — | — | La₂O₃: 80%, Nb₂O₅: 20% | 49 | 3.5 | Good | Good | Example |
| 12 | S3 | 270 | R3 | 30 | La₂O₃: 80%, Nb₂O₅: 20% | 49 | 3.2 | Good | Good | Example |
| 13 | S4 | 260 | — | — | TiO₂: 80%, La₂O₃: 20% | 18 | 9.8 | Very good | Good | Example |
| 14 | S4 | 260 | R1 | 40 | MgO: 80%, La₂O₃: 20% | 18 | 9.9 | Very good | Good | Example |
| 15 | S5 | 260 | — | — | TiO₂: 100% | 21 | 1.5 | Very good | Good | Example |
| 16 | S5 | 260 | R3 | 40 | SiO₂: 50%, CaO: 50% | 26 | 1.1 | Very good | Good | Example |
| 17 | S6 | 260 | R1 | 40 | La₂O₃: 100% | 20 | 0.13 | Good | Very good | Example |
| 18 | S7 | 260 | R2 | 40 | Ta₂O₅: 100% | 23 | 0.59 | Good | Very good | Example |
| 19 | S8 | 260 | R1 | 40 | La₂O₃: 80%, Nb₂O₅: 20% | 40 | 1.4 | Good | Very good | Example |
| 20 | S9 | 290 | R1 | 10 | ZrO₂: 80%, La₂O₃: 20% | 20 | 2.5 | Very good | Very good | Example |
| 21 | S10 | 260 | R3 | 40 | CaO: 100% | 22 | 2.1 | Very good | Very good | Example |
| 22 | S11 | 260 | R1 | 40 | TiO₂: 60%, SiO₂: 40% | 20 | 1.9 | Very good | Very good | Example |
| 23 | S12 | 260 | R1 | 40 | La₂O₃: 100% | 20 | 1.3 | Very good | Very good | Example |
| 24 | S13 | 260 | R2 | 40 | Ta₂O₅: 100% | 25 | 1.2 | Very good | Very good | Example |
| 25 | S14 | 260 | R1 | 40 | La₂O₃: 80%, Nb₂O₅: 20% | 45 | 0.98 | Very good | Very good | Example |
| 26 | S15 | 260 | R1 | 40 | TiO₂: 80%, La₂O₃: 20% | 19 | 2.0 | Excellent | Excellent | Example |
| 27 | S16 | 260 | R2 | 40 | TiO₂: 100% | 21 | 3.5 | Excellent | Excellent | Example |
| 28 | S17 | 260 | R1 | 40 | SiO₂: 100% | 23 | 5.8 | Excellent | Excellent | Example |
| 29 | S18 | 260 | R1 | 40 | TiO₂: 50%, CaO: 50% | 35 | 3.9 | Excellent | Excellent | Example |
| 30 | S19 | 260 | R3 | 40 | SiO₂: 50%, ZrO₂: 50% | 33 | 4.1 | Excellent | Excellent | Example |
| 31 | S20 | 260 | R1 | 40 | TiO₂: 60%, SiO₂: 40% | 17 | 2.8 | Excellent | Excellent | Example |
| 32 | S21 | 260 | R1 | 40 | SiO₂: 50%, CaO: 20%, | 15 | 2.4 | Excellent | Excellent | Example |
| | | | | | MgO: 30% | | | | | |
| 33 | S22 | 260 | R2 | 40 | TiO₂: 80%, ZrO₂: 20% | 23 | 2.5 | Excellent | Excellent | Example |

### <Corrosion Test Result>

The corrosion resistance evaluation results by the corrosion tests are shown in Table 4. Nos. 1 to 4 are comparative examples and are aluminum alloys deviating from any one of the stipulations of the present invention. In those examples, corrosion penetration or local corrosion of 100 μm or more in depth is generated and it is confirmed that the corrosion resistance is insufficient. In No. 2, since the average particle size of the oxide is too small, defects such as cracks are generated in the film at the drying after the oxide dispersed liquid is applied and hence the corrosion prevention effect of the film is insufficient. In No. 3, since the average particle size of the oxide is too large, the film is not dense and the corrosion prevention effect is insufficient. In No. 4, since the oxide film is too thin, the corrosion prevention effect is insufficient and penetration corrosion is caused.

In contrast to the comparative examples, in each of Nos. 5 to 33 satisfying the stipulations of the present invention, it is found that corrosion penetration does not occur, the local corrosion depth is suppressed to less than 100 μm at most, and superior corrosion resistance is exhibited. In No. 13 or the like of forming a film having oxide particles containing one or more kinds of TiO₂, ZrO₂, SiO₂, MgO, and CaO by 80% by mass or more in total in particular, the corrosion resistance at Test 1 improves further. Further, in No. 17 or the like of optimizing the chemical components of an aluminum alloy, the corrosion resistance improvement effect at Test 2 increases further. In No. 20 or the like of satisfying both of them, it can be said that the corrosion resistance improves further. Further, it can be said that the synergetic effect increases further by adding Cr, Zr, and/or Mg to an aluminum alloy.

Further, the effect of the present invention is similarly recognized in both an aluminum alloy single material and a clad material of forming a skin material on the other surface.

As stated above, it can be said that a surface-treated aluminum alloy and a surface-treated aluminum alloy clad material according to the present invention are suitable for a heat exchanger or the like used in an automobile.

1. A surface-treated aluminum alloy, wherein:
a surface film is formed at least on one surface of the aluminum alloy;
the thickness of the surface film is 0.1 to 10 μm;
a material forming the surface film contains oxides having a standard free energy of formation of 500 kJ/mol or less at a temperature of 500 K by 80% by mass or more in total; and
the average particle size of the oxides is 5 to 50 nm

2. A surface-treated aluminum alloy according to claim 1, wherein the surface film contains one or more kinds selected from the group consisting of TiO₂, ZrO₂, SiO₂, MgO, and CaO by 80% by mass or more in total as the oxides.

3. A surface-treated aluminum alloy according to claim 1, wherein the aluminum alloy comprises
Si: 0.3% to 1.5% by mass,
Mn: 0.6% to 2.0% by mass,
Cu: 0.1% to 3.0% by mass,
Ti: 0.05% to 0.5% by mass,
Fe: 0.01% to 0.5% by mass, and
Zn: 0.5% by mass or less, with the remainder consisting of Al and unavoidable impurities.

4. A surface-treated aluminum alloy according to claim 3, wherein the aluminum alloy further comprises one or more kinds selected from
Cr: 0.05% to 0.5% by mass,
Zr: 0.05% to 0.5% by mass, and
Mg: 0.05% to 1.0% by mass.

5. A surface-treated aluminum alloy clad material, wherein:
a skin material is formed on one surface of an aluminum alloy as a core material and a surface film is formed on the other surface;
the skin material comprises an Al—Si based alloy having a thickness of 10 μm or more; and
the core material on the surface of which the surface film is formed is a surface-treated aluminum alloy according to claim 1.

6. A surface-treated aluminum alloy according to claim 1 used for a heat exchanger in an automobile.

7. A surface-treated aluminum alloy clad material according to claim 5 used for a heat exchanger in an automobile.
